(19) United States
(12) Patent Application Publication
(10) Pub. No.: US 2025/0285367 A1
(43) Pub. Date: Sep. 11, 2025

(54) AI-POWERED TECHNIQUES FOR AUTOMATICALLY CONVERTING 2D UI FEATURES TO 3D UI FEATURES FOR XR SPACE

(71) Applicant: Samsung Electronics Co., Ltd., Suwon-si (KR)

(72) Inventors: Yujie Jiang, San Jose, CA (US); Edgar Charles Evangelista, San Jose, CA (US); Ajinkya Waghulde, Castro Valley, CA (US); Hiroshi Horii, Pleasanton, CA (US)

(21) Appl. No.: 19/067,263

(22) Filed: Feb. 28, 2025

Related U.S. Application Data
(60) Provisional application No. 63/562,629, filed on Mar. 7, 2024.

(51) Int. Cl. G06T 15/20; G06T 3/60; G06T 13/20; G06T 15/60; G06V 20/20

(52) U.S. Cl. CPC G06T 15/205; G06T 3/60; G06T 13/20; G06T 15/60; G06T 2200/24; G06V 20/20

(57) ABSTRACT

A method for automatically converting a two-dimensional (2D) user interface (UI) feature to a three-dimensional (3D) UI feature suitable for an extended reality (XR) environment includes obtaining a design for the 2D UI feature. The method also includes analyzing elements of the design for the 2D UI feature. The method further includes determining spatial coordinates in a 3D XR space corresponding to each element of the design for the 2D UI feature. In addition, the method includes rendering elements for the 3D UI feature at the determined spatial coordinates to form the 3D UI feature.

### CROSS-REFERENCE TO RELATED APPLICATION AND PRIORITY CLAIM

This application claims priority under 35 U.S.C. § 119 (e) to U.S. Provisional Patent Application No. 63/562,629 filed on Mar. 7, 2024. This provisional application is hereby incorporated by reference in its entirety.

### TECHNICAL FIELD

This disclosure relates generally to user interfaces of extended reality (XR) environments. More specifically, this disclosure relates to artificial intelligence (AI)-powered techniques for automatically converting two-dimensional (2D) user interface (UI) features to three-dimensional (3D) UI features for XR space.

### BACKGROUND

Extended reality (XR), which includes virtual reality (VR), augmented reality (AR), and mixed reality (MR), has seen significant advancements in recent years. These technologies have found applications in various fields including gaming, education, healthcare, and industrial training among others. A common element in these applications is the use of interactive elements or “widgets” that allow users to interact with virtual environments.

### SUMMARY

This disclosure relates to artificial intelligence (AI)-powered techniques for automatically converting two-dimensional (2D) user interface (UI) features to three-dimensional (3D) UI features for extended reality (XR) space.

In a first embodiment, a method for automatically converting a 2D UI feature to a 3D UI feature suitable for an XR environment includes obtaining a design for the 2D UI feature. The method also includes analyzing elements of the design for the 2D UI feature. The method further includes determining spatial coordinates in a 3D XR space corresponding to each element of the design for the 2D UI feature. In addition, the method includes rendering elements for the 3D UI feature at the determined spatial coordinates to form the 3D UI feature.

Any single one or any combination of the following features may be used with the first embodiment. The method may include determining interactions for the elements of the 3D UI feature in the 3D XR space. The method may include translating the interactions into commands based on corresponding commands for the elements of the design for the 2D UI feature, and the translation may be based at least in part on one or more user considerations. Analyzing the elements of the design for the 2D UI feature may include identifying, using an AI or machine learning (ML) model, at least one of: buttons, text, graphics, backing, statistics, time/date, chunking, decorative elements, or media display. Determining the spatial coordinates in the 3D XR space may include identifying, using an AI or ML model, depth values for the elements for the 3D UI feature based on one or more depth profiles. The one or more depth profiles may be based on a hierarchy of the elements for the 3D UI feature. The method may include adjusting at least one of a size or an orientation of the elements for the 3D UI feature in the 3D XR space based on a user experience during interactions with the 3D UI feature. The method may include adding one or more dynamic effects to one or more of the elements of the 3D UI feature. The one or more dynamic effects may include at least one of: animation, shadowing, reflection, or ambient interaction based on user presence.

In a second embodiment, an electronic device for automatically converting a 2D UI feature to a 3D UI feature suitable for an XR environment includes at least one processing device. The at least one processing device is configured to obtain a design for the 2D UI feature, analyze elements of the design for the 2D UI feature, determine spatial coordinates in a 3D XR space corresponding to each element of the design for the 2D UI feature, and render elements for the 3D UI feature at the determined spatial coordinates to form the 3D UI feature.

Any single one or any combination of the following features may be used with the second embodiment. The at least one processing device may be configured to determine interactions for the elements of the 3D UI feature in the 3D XR space. The at least one processing device may be configured to translate the interactions into commands based on corresponding commands for the elements of the design for the 2D UI feature, and the translation may be based at least in part on one or more user considerations. The at least one processing device may be configured to analyze the elements of the design for the 2D UI feature by identifying, using an AI or ML model, at least one of: buttons, text, graphics, backing, statistics, time/date, chunking, decorative elements, or media display. The at least one processing device may be configured to determine the spatial coordinates in the 3D XR space by identifying, using an AI or ML model, depth values for the elements for the 3D UI feature based on one or more depth profiles. The one or more depth profiles may be based on a hierarchy of the elements for the 3D UI feature. The at least one processing device may be configured to adjust at least one of a size or an orientation of the elements for the 3D UI feature in the 3D XR space based on a user experience during interactions with the 3D UI feature. The at least one processing device may be configured to add one or more dynamic effects to one or more of the elements of the 3D UI feature. The one or more dynamic effects may include at least one of: animation, shadowing, reflection, or ambient interaction based on user presence.

In a third embodiment, a non-transitory machine readable medium for automatically converting a 2D UI feature to a 3D UI feature suitable for an XR environment contains instructions that when executed cause at least one processor of an electronic device to obtain a design for the 2D UI feature. The non-transitory machine readable medium also contains instructions that when executed cause the at least one processor to analyze elements of the design for the 2D UI feature, determine spatial coordinates in a 3D XR space corresponding to each element of the design for the 2D UI feature, and render elements for the 3D UI feature at the determined spatial coordinates to form the 3D UI feature.

Any single one or any combination of the following features may be used with the third embodiment. The instructions, when executed, may cause the at least one processor to determine interactions for the elements of the 3D UI feature in the 3D XR space. The instructions, when executed, may cause the at least one processor to translate the interactions into commands based on corresponding commands for the elements of the design for the 2D UI feature, and the translation may be based at least in part on one or more user considerations. The instructions, when executed, may cause the at least one processor to analyze the elements of the design for the 2D UI feature by identifying, using an AI or ML model, at least one of: buttons, text, graphics, backing, statistics, time/date, chunking, decorative elements, or media display. The instructions, when executed, may cause the at least one processor to determine the spatial coordinates in the 3D XR space by identifying, using an AI or ML model, depth values for the elements for the 3D UI feature based on one or more depth profiles. The one or more depth profiles may be based on a hierarchy of the elements for the 3D UI feature. The instructions, when executed, may cause the at least one processor to adjust at least one of a size or an orientation of the elements for the 3D UI feature in the 3D XR space based on a user experience during interactions with the 3D UI feature. The instructions, when executed, may cause the at least one processor to add one or more dynamic effects to one or more of the elements of the 3D UI feature. The one or more dynamic effects may include at least one of: animation, shadowing, reflection, or ambient interaction based on user presence.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration in accordance with this disclosure;

FIG. 2 illustrates an example process of automatically converting two-dimensional (2D) user interface (UI) features to three-dimensional (3D) UI features for an extended reality (XR) space in accordance with this disclosure;

FIG. 3 illustrates an example automation system for artificial intelligence (AI)-powered 2D-to-3D UI feature conversion automation in accordance with this disclosure;

FIG. 4 illustrates an example training system for AI-powered 2D-to-3D UI feature conversion automation in accordance with this disclosure;

FIG. 5 illustrates an example 2D widget UI for use in connection with AI-powered 2D-to-3D UI feature conversion automation in accordance with this disclosure;

FIGS. 6A and 6B illustrate example analysis and segmentation of 2D widget UI elements during AI-powered 2D-to-3D UI feature conversion automation in accordance with this disclosure;

FIG. 7 illustrates example labeling of 2D widget UI element categories during AI-powered 2D-to-3D UI feature conversion automation in accordance with this disclosure;

FIGS. 8A and 8B illustrate example chunking of 2D widget UI elements from the UI display of FIG. 7 during AI-powered 2D-to-3D UI feature conversion automation in accordance with this disclosure;

FIGS. 9A and 9B illustrate example techniques for determining 2D widget UI element positions and sizes during AI-powered 2D-to-3D UI feature conversion automation in accordance with this disclosure;

FIGS. 10A and 10B illustrate example determination of 2D widget UI size and placements on a display for different types of 2D widget UIs during AI-powered 2D-to-3D UI feature conversion automation in accordance with this disclosure;

FIGS. 11A and 11B illustrate example spatial mapping for 2D widget UI layering in generating a counterpart 3D widget UI during AI-powered 2D-to-3D UI feature conversion automation in accordance with this disclosure;

FIGS. 12A through 13C illustrate example 2D widget UIs and counterpart 3D widget UIs generated with AI-powered 2D-to-3D UI feature conversion automation in accordance with this disclosure;

FIGS. 14A through 14G illustrate another example 2D widget UIs and counterpart 3D widget UIs generated with AI-powered 2D-to-3D UI feature conversion automation in accordance with this disclosure;

FIGS. 15A and 15B illustrate an example 2D widget UI grid mapping to a counterpart 3D widget UI grid during AI-powered 2D-to-3D UI feature conversion automation in accordance with this disclosure;

FIGS. 16A through 16D illustrate example grid mappings for specific 2D widget UIs to counterpart 3D widget UIs during AI-powered 2D-to-3D UI feature conversion automation in accordance with this disclosure;

FIGS. 17A and 17B illustrate example pivot point, center, and tilting for a three-layer 3D widget UI feature generated during AI-powered 2D-to-3D UI feature conversion automation in accordance with this disclosure;

FIGS. 18A through 19C illustrate example solutions to avoiding protrusion of 3D widget UI feature elements generated during AI-powered 2D-to-3D UI feature conversion automation in accordance with this disclosure;

FIGS. 20A through 22C illustrate examples of making widget elements more interesting during AI-powered 2D-to-3D UI feature conversion automation in accordance with this disclosure;

FIG. 23 illustrates an example portion of AI-powered 2D-to-3D UI feature conversion automation relating to object matching in accordance with this disclosure;

FIG. 24 illustrates an example portion of AI-powered 2D-to-3D UI feature conversion automation relating to adding dynamic real-time effects in accordance with this disclosure;

FIGS. 25A through 25E illustrate a specific example of AI-powered 2D-to-3D UI feature conversion automation in accordance with this disclosure;

FIGS. 26A through 26C illustrate use of the 3D widget UI of FIG. 25D or the 3D widget UI of FIG. 25E in XR space in accordance with this disclosure

FIG. 27 illustrates an example process for automatically converting 2D UI features in an app to 3D UI features suitable for an XR environment in accordance with this disclosure.

### DETAILED DESCRIPTION

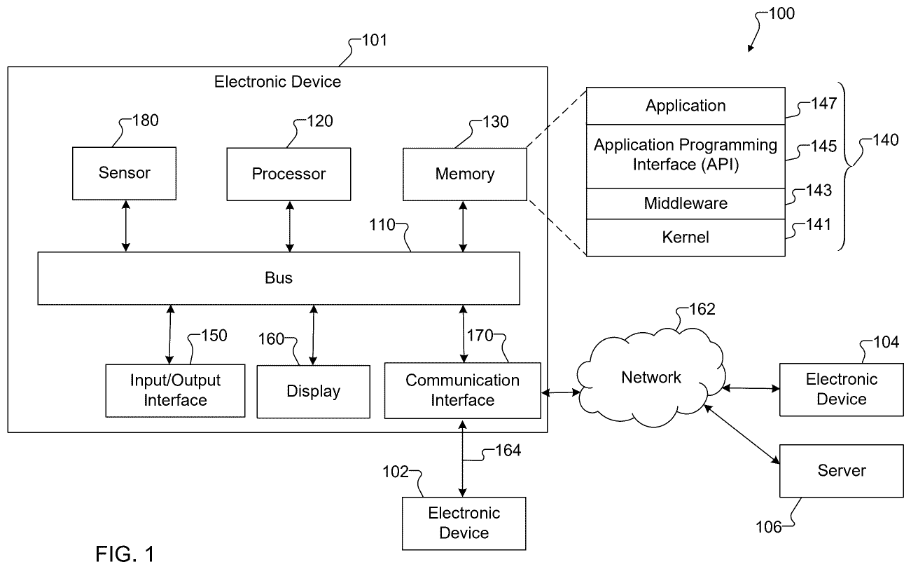

FIGS. 1 through 27, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR), which includes virtual reality (VR), augmented reality (AR), and mixed reality (MR), has seen significant advancements in recent years. These technologies have found applications in various fields including gaming, education, healthcare, and industrial training among others. A common element in these applications is the use of interactive elements or “widgets” that allow users to interact with virtual environments.

Traditionally, two-dimensional (2D) widgets have been designed and implemented. While 2D widgets are suitable for flat screen-based interfaces, the immersive and spatial nature of XR environments may not be fully utilized. For example, flat widget UIs designed for a 2D display, when rendered in an XR environment, may often appear stretched in space and lack depth. By contrast, a three-dimensional (3D) widget can provide a more intuitive and engaging user experience in an XR environment by allowing user interactions from any angle and by incorporating depth and spatial relationships.

Unfortunately, the process of converting 2D widgets into 3D widgets or otherwise designing 3D widgets can be time-consuming and can require specialized knowledge in 3D modeling and XR programming. Furthermore, a vast amount of existing 2D widgets and interfaces could be utilized in XR applications if efficient conversion techniques were available. Attempts to address these issues often involve either manual conversion processes or do not adequately maintain the functionality and aesthetics of the original 2D widgets during conversion. This disclosure provides various artificial intelligence (AI)-powered techniques for automatically converting 2D widget user interfaces (UIs) to 3D widget UIs for XR space.

FIG. 1 illustrates an example network configuration 100 that may be employed for automatically converting 2D UI features to 3D UI features for an XR space in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to AI-powered techniques for automatically converting 2D widget UIs to 3D widget UIs for XR space.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to AI-powered techniques for automatically converting 2D widget UIs to 3D widget UIs for XR space. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to AI-powered techniques for automatically converting 2D widget UIs to 3D widget UIs for XR space.

Although FIG. 1 illustrates one example of a network configuration 100, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

The following description relates to a process, an automation system, a model training system, etc. for automatically converting 2D UI features to 3D UI features for XR space. Note that while often described as being used to convert 2D widget UIs to 3D widget UIs, the same process, automation system, model training system, etc. can readily scale to other 2D UI assets and may be employed with UI features other than widgets. Moreover, while the specific examples of UI features depicted in the drawings and used in the explanations below may represent widget UIs, UI assets other than widgets may be used.

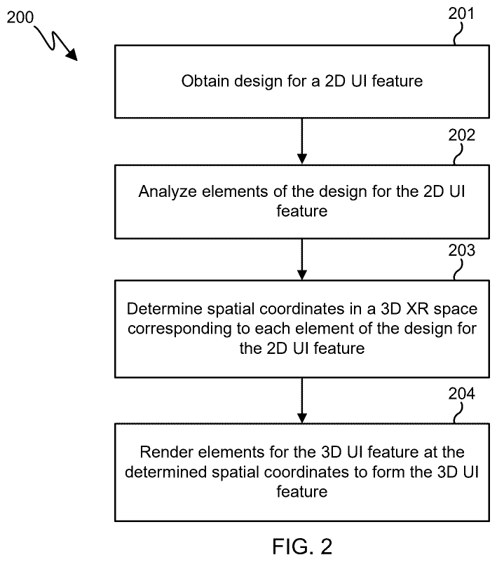

FIG. 2 illustrates an example process 200 for automatically converting 2D UI features to 3D UI features suitable for an XR environment in accordance with this disclosure. For case of explanation, the process 200 of FIG. 2 is described as being performed using the server 106 in the network configuration 100 of FIG. 1, such as to create 3D UI features for the electronic device 101. However, the process 200 may be performed using any other suitable device(s), such as the electronic device 101, and in any other suitable system(s).

As shown in FIG. 2, the process 200 begins by obtaining a design for a 2D UI feature (step 201). The 2D UI feature may include text (such as static or representing real-time data), graphics or other visual elements (such as decorative elements), user controls (such as buttons or radio buttons), and interactions between elements that correspond to user commands. Elements of the design for the 2D UI feature are analyzed (step 202). In some cases, the analysis may include element labeling, segmentation of the elements for the 2D UI feature, “chunking” or grouping of some elements, determination of display position and size for each element, and the like.

Spatial coordinates in a 3D XR space corresponding to each element of the design for the 2D UI feature are determined (step 203). In some cases, this determination may involve determining a grid mapping between 2D grid dimensions and corresponding 3D grid block dimensions, which may be dependent upon a XR space surface (horizontal or vertical) on which the 3D UI feature will be displayed. Depth profiles for elements of the 3D UI feature may as be determined based on a hierarchy. Object rendering is performed for the elements for the 3D UI feature at the determined spatial coordinates to form the 3D UI feature (step 204). In some case, rendering may involve determining position and orientation, extrusion of an element, or adjustment of elements to avoid protrusion from a 3D UI grid block.

Although FIG. 2 illustrates one example of a process 200 for automatically converting 2D UI features to 3D UI features suitable for an XR environment, various changes may be made to FIG. 2. For example, while shown as a series of steps, various steps in FIG. 2 could overlap, occur in parallel, occur in a different order, or occur any number of times (including zero times).

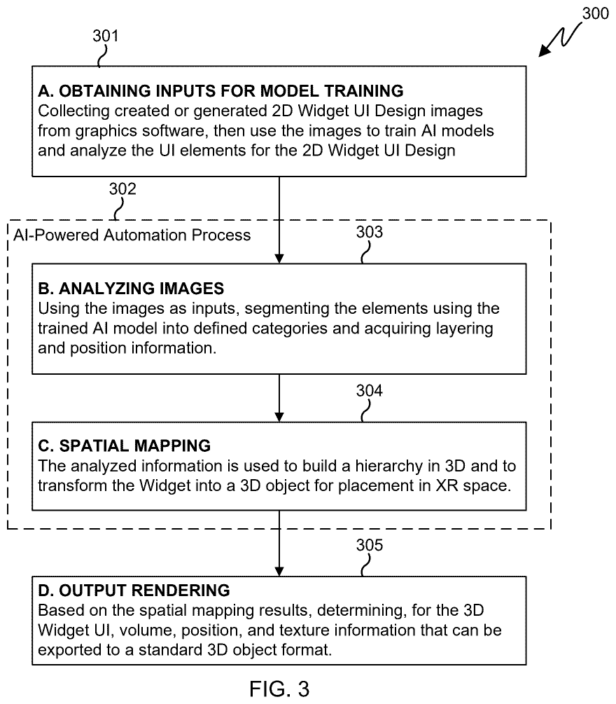

FIG. 3 illustrates an example automation system 300 for AI-powered 2D-to-3D UI feature conversion automation in accordance with this disclosure. For ease of explanation, the automation system 300 of FIG. 3 is described as being implemented within the server 106 in the network configuration 100 of FIG. 1, which may interact with the electronic device 101 to install a 3D UI feature on the electronic device 101. However, the automation system 300 may be implemented using any other suitable device(s) and in any other suitable system(s), and the 3D UI feature may be provided to any other suitable device(s).

As shown in FIG. 3, inputs for model training 301 are obtained, such as by acquiring 2D widget UI design images as learning materials, which is explained in further detail below. In some cases, created or generated 2D widget UI design images may be collected using graphics software (such as FIGMA or SKETCH). In some cases, the images are used to train one or more AI models. In other cases, the images are analyzed by one or more AI trained models. In some embodiments, 2D widget UI design images can be acquired or generated by screenshots or graphic software. Example formats could include Portable Network Graphic (PNG), Joint Photographic Experts Group (JPEG), or any other static images formats.

An AI-powered automation process 302 operates on the inputs for model training 301. For example, within the AI-powered automation process 302, image analysis 303 may be performed on the 2D widget UI design images. Using those images as inputs, elements of the 2D widget UI designs can be segmented into defined categories, and layering and position information for those elements can be acquired. The UI elements can be analyzed using the image process and segmentation, and (ultimately) the elements can be prepared to be rendered into 3D space using the trained AI model(s).

Spatial mapping 304 can be performed with the analyzed information used to build a hierarchy in 3D space that transforms the elements of each 2D widget into 3D object(s) for placement in XR space. In some embodiments, the one or more trained AI models may aim to both (i) convert 2D widget UI designs into 3D widget UIs in XR space and (ii) render the 3D widget UIs in a user-friendly way that accommodates 3D widget UI user interactions. The output of the AI-powered automation process 302 is employed for output rendering 305. Based on the spatial mapping results, attributes (such as volume, position, and texture information) can be determined for each 3D widget UI, such as in a manner that can be exported to a standard 3D object format or other format. Position and sizing data of each widget may be extracted, together with the components of each widget in 2D that may be mapped to XR space. 3D widget objects that can be imported in XR space can be generated for subsequent use.

Although FIG. 3 illustrates one example of an automation system 300 for AI-powered 2D-to-3D UI feature conversion automation, various changes may be made to FIG. 3. For example, while shown as discrete functions operating serially, various functions in FIG. 3 could be combined, separated, or arranged to operate in a different order or to operate in parallel.

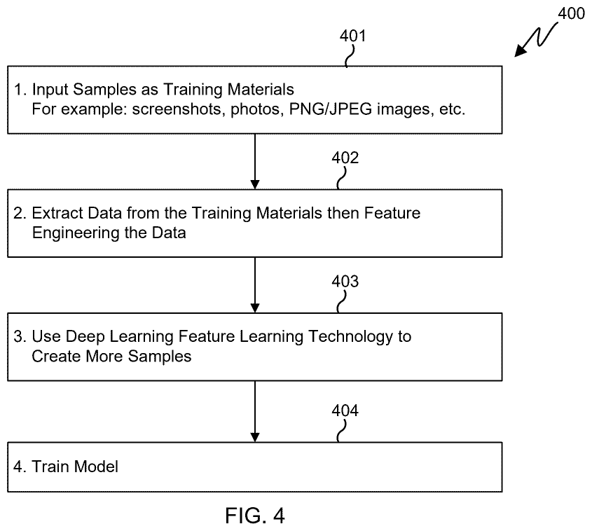

FIG. 4 illustrates an example training system 400 for AI-powered 2D-to-3D UI feature conversion automation in accordance with this disclosure. For case of explanation, the training system 400 of FIG. 4 is described as being implemented within the server 106 in the network configuration 100 of FIG. 1 to generate a 3D UI feature for use by the electronic device 101. However, the training system 400 may be implemented using any other suitable device(s) and in any other suitable system(s), and the 3D UI feature may be provided to any other suitable device(s).

As shown in FIG. 4, image samples that have been extracted from 2D widget UIs are input into a deep learning AI model as learning materials (operation 401). In some embodiments, the image input samples may include any combination of screenshots, photos, or graphics image formats (as well as other formats). Using the extracted data, data classification can be performed, and features can be built for understanding of deep learning training. Data extracted from the training materials is used for feature engineering (operation 402). Using deep learning feature learning, the data classifications may be learned and employed to automatically generate more high-quality samples of widgets for the AI training (operation 403). With the generated body of learning materials (collected and synthetically generated), the AI model can be trained (operation 404).

Although FIG. 4 illustrates one example of a training system 400 for AI-powered 2D-to-3D UI feature conversion automation, various changes may be made to FIG. 4. For example, while shown as discrete functions operating serially, various functions in FIG. 4 could be combined, separated, or arranged to operate in a different order or to operate in parallel.

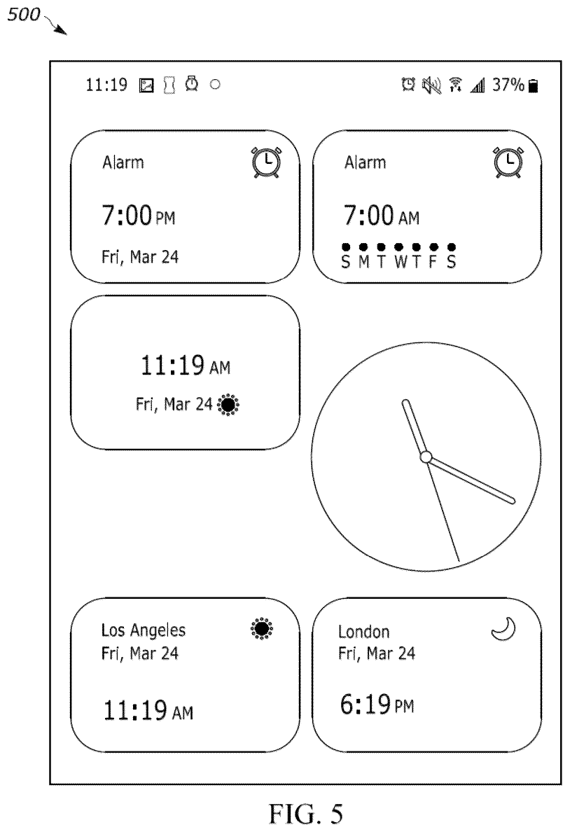

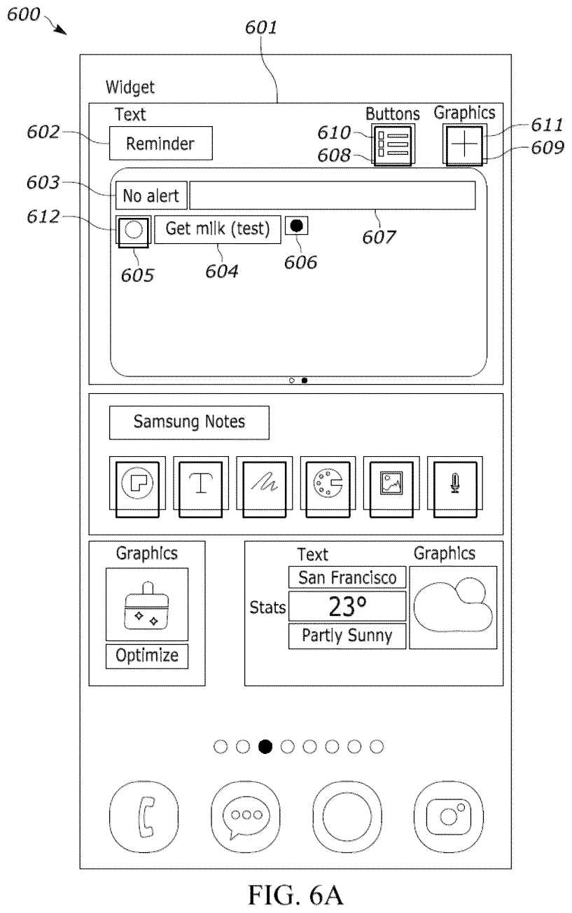

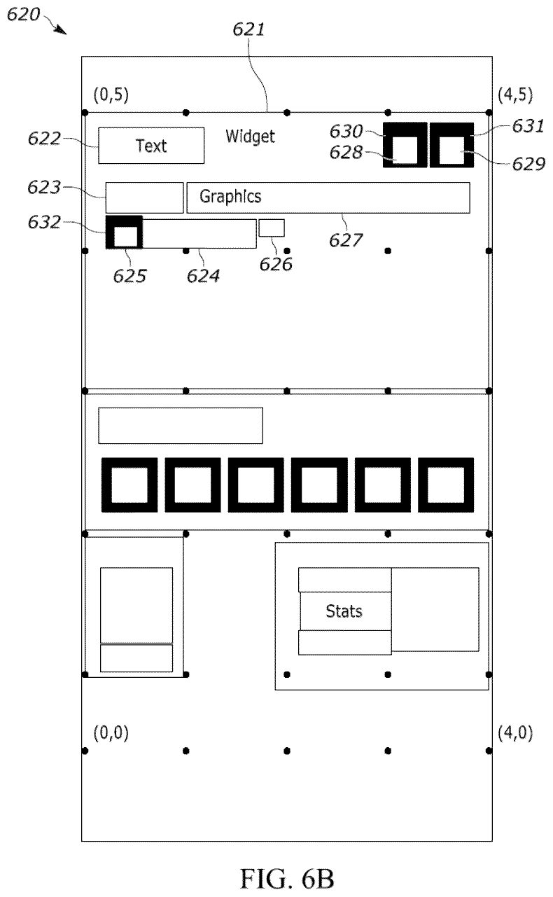

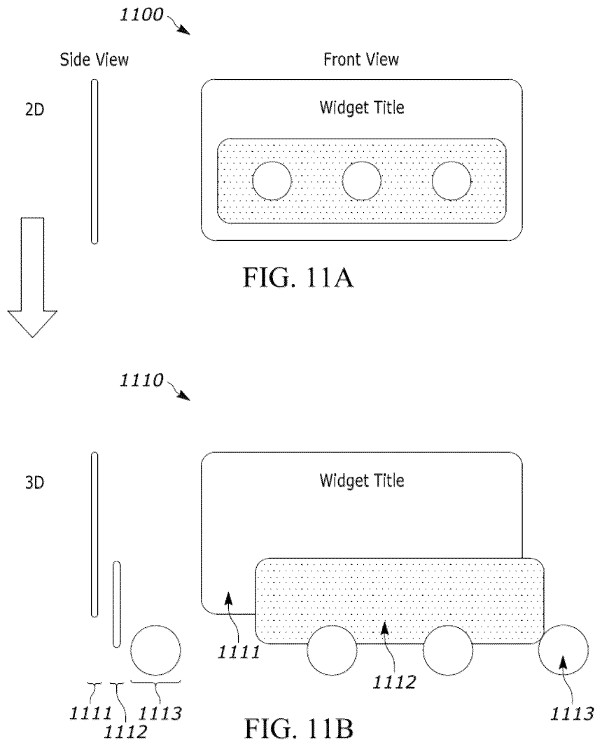

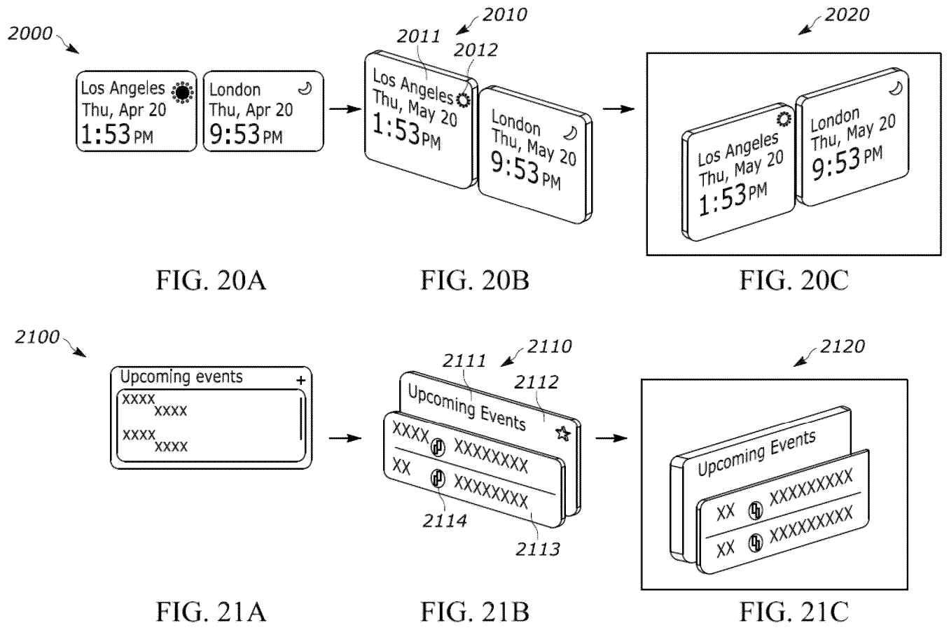

Specific examples are described below to better illustrate the automation system 300 of FIG. 3 and/or the training system 400 of FIG. 4 for AI-powered 2D-to-3D UI feature conversion automation, such as for generating 3D UI features for the electronic device 101. More specifically, FIG. 5 corresponds to inputs for model training 301 in FIG. 3, FIGS. 6A through 10B correspond to image analysis 303 in FIG. 3, FIGS. 11A through 19C correspond to spatial mapping 304 in FIG. 3, and FIGS. 20A through 24 correspond to output rendering 305 in FIG. 3.

FIG. 5 illustrates an example 2D widget UI for use in connection with AI-powered 2D-to-3D UI feature conversion automation in accordance with this disclosure. More specifically, FIG. 5 illustrates a clock/timer/alarm widget 500. In analyzing elements from 2D widgets (such as during image analysis 303), a starting point can be to identify widget features on 2D screens. Widgets on 2D displays (such as in phones or tablet computers) are often designed for touchscreen 2D surfaces and are therefore generally flat with layered content for various elements, which could differ for each widget.

Widgets may have variable sizes, some of which may be resized by a user. Widget features also often follow a grid structure, where the widget shape and size are aligned to the grid cells on the device screen. Widgets can have a backing that forms the base on which all elements are placed and enclosed and which also defines the overall widget shape. The elements on top of the backing element can include images, text, and interactive components such as buttons, normally within one of seven main categories discussed below. These elements may be arranged in layers and could be interpreted into two to three layers of depth in XR space based on the widget and the associated information hierarchy (explained below). Some elements may be chunked together to keep relevant information together and may be aligned and moved accordingly when the widget is scaled or the grid size is changed (also explained below).

Segmenting an image may examine two main factors. First, widget UI element categories, which are specific UI elements on the widget, may be classified among detected elements into specific categories (such as buttons, graphics, text, and so on). Once the elements are detected, the segmented elements may be assigned to a specific layer. Second, element position and dimensions, which correspond to widget position on a display and associated sizing information with respect to the 2D screen, may be determined. For example, setting the bottom left corner as the origin (0,0) of a mobile device screen, dimension/size and coordinate information relevant to the 2D screen can be obtained for each widget.

FIGS. 6A and 6B illustrate example analysis and segmentation of 2D widget UI elements during AI-powered 2D-to-3D UI feature conversion automation in accordance with this disclosure. For case of explanation, two UI displays 600, 620 of FIGS. 6A and 6B are described as being used together with the automation system 300 of FIG. 3 and/or the training system 400 of FIG. 4 for generation of 3D UI features for the electronic device 101. However, the UI displays 600, 620 may be used with any other suitable device(s) and in any other suitable system(s), and the 3D UI features may be provided to any other suitable device(s).

The UI display 600 of FIG. 6A includes a reminders widget 601 that, upon analysis, may be determined to include text fields 602-604, graphics 605-609, and user controls including buttons 610-611 and a radio button 612. During analysis and segmentation, a mapping of the widget can determine that the reminders widget 601 occupies an area 621 within the display space that is defined by grid coordinates (0,3), (0,5), (4,5), (4,3). The 2D UI features may be determined to have the size, position, and classification of text field areas 622-624, graphic areas 625-629, and user control areas including button areas 630-631 and a radio button area 632.

During labeling for the 2D widget UI element categories, 2D UI elements may be extracted and classified as follows:
1. Backing: These elements relating to the underlying UI elements may be utilized for defining the shape of the widget in the area, providing a base for the widget component to sit on, and allowing system-level user interaction (such as placing and resizing the widget).
2. Text: The components in text formats may include datasets, time/date, statistics, widget title, paragraphs, and any other text-based data.
3. Chunking: Relevant components may be grouped together and typically cannot be separated for display or interaction.
4. Buttons: Any buttons or other interactive items on the widgets
5. Real-time data: These elements may relate to data such as diagrams, charts, and symbols on widgets, including real-time or live data.
6. Visual Elements: These elements may include icons, images, drawings, illustrations, animated graphics, and any visual elements utilized for decoration purposes.
7. Imported media files: Elements such as videos, images, etc.

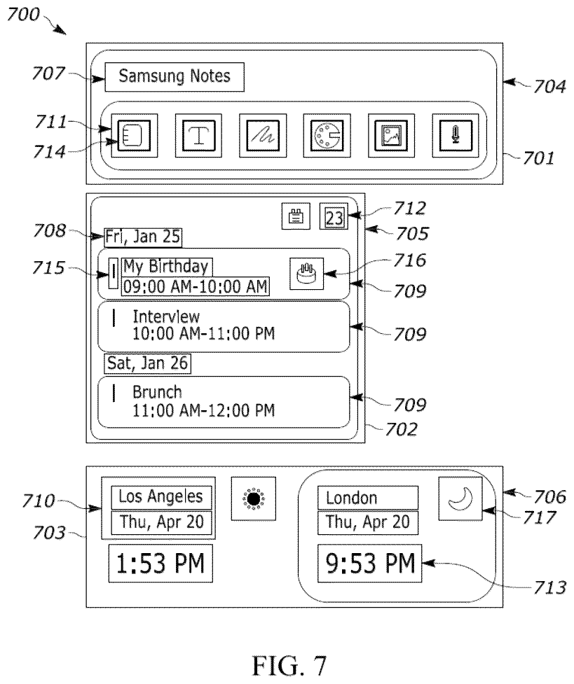

FIG. 7 illustrates example labeling of 2D widget UI element categories during AI-powered 2D-to-3D UI feature conversion automation in accordance with this disclosure. For ease of explanation, a UI display 700 of FIG. 7 is described as being used together with the automation system 300 of FIG. 3 and/or the training system 400 of FIG. 4 for generation 3D UI features for the electronic device 101. However, the UI display 700 may be used with any other suitable device(s) and in any other suitable system(s), and the 3D UI features may be provided to any other suitable device(s).

As shown in FIG. 7, the elements of three widgets 701, 702, and 703 depicted in the UI display 700 are labeled according to the above-described categories and include backing elements 704-706, text elements 707-708 (among others depicted in FIG. 7), chunkings 709 (three depicted for elements within the widget 702), chunkings 710 (for elements in the widget 703), button elements 711-712, a real-time data element 713, and visual elements 714-717. Chunking is a term for grouping relevant UI elements (such as widget UI information to be grouped together) that serve specific a user interaction purpose. The size of a chunking may depend on the grouped information. Chunked elements can be aligned and moved together for user interactions and may be treated as a single UI element for those purposes. In some cases, chunked elements can include images, text, graphics elements, or even motion graphics.

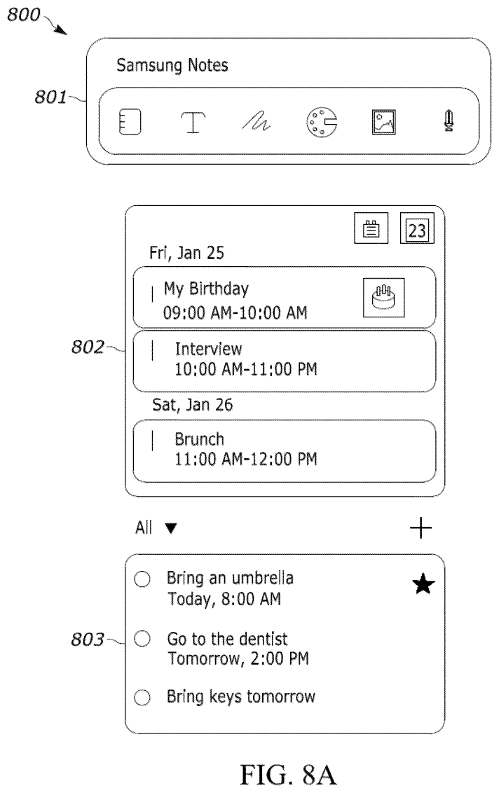

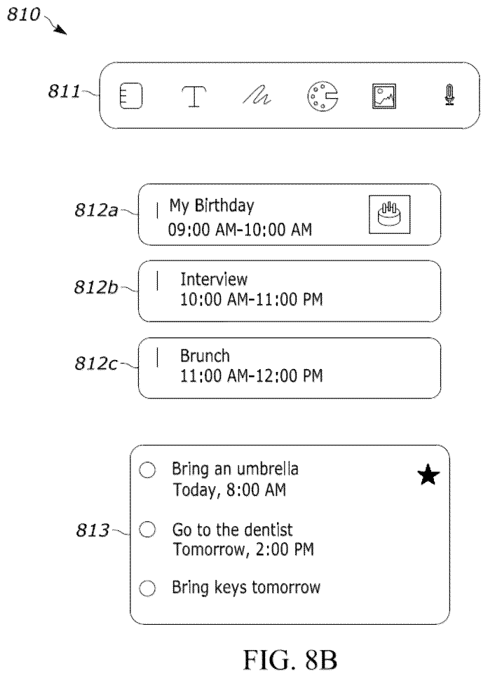

FIGS. 8A and 8B illustrate example chunking of 2D widget UI elements from the UI display 700 of FIG. 7 during AI-powered 2D-to-3D UI feature conversion automation in accordance with this disclosure. More specifically, FIG. 8A depicts three 2D UI widgets 801-803. FIG. 8B depicts the corresponding chunking of elements for each of those widgets, which includes chunking 811 of UI elements for the 2D UI widget 801, chunkings 812a-812c of UI elements for the 2D UI widget 802, and chunking 813 of UI elements for the 2D UI widget 803.

During segmentation of input images for 2D UI features, the input images can be divided into multiple parts that could belong to a specific group. In some cases, this clustering can be based on texture, text detected, color, edges of UI elements detected, etc. Region-based semantic segmentation may be employed to recognize and label regions in the input image that are chunked together later when transforming into XR space. The datasets built for widgets that group various UI elements can be used as input for training and recognition. The clusters formed can be segmented by edges (such as interactive elements like buttons or text box) and labeled accordingly.

All elements can be enclosed in one widget panel so the relative 2D position of each element on the respective panel can be recorded. Some elements might overlap, such as when text with alphanumeric characters might be overlaid onto an image. In such cases, the image and text can be identified as separate elements and labeled accordingly, but layering information can also be recorded to keep track of how the elements are stacked. For instance, each element could have some Z-dimension or depth value added, where the widget base panel is below every other element. The base panel's dimension and size can be recorded, since some of the widgets can be resized and the layout accordingly updated. Once all elements are segmented and labeled, the elements can be rearranged when transformed into XR space based on position in 3D space and on which grid surface each element has been placed. Each element detected may have a pivot location used for tilt and offset when transformed into XR space. Some relevant elements that are labeled and grouped together (chunked) could have a single pivot at the center of a bounding box formed after grouping.

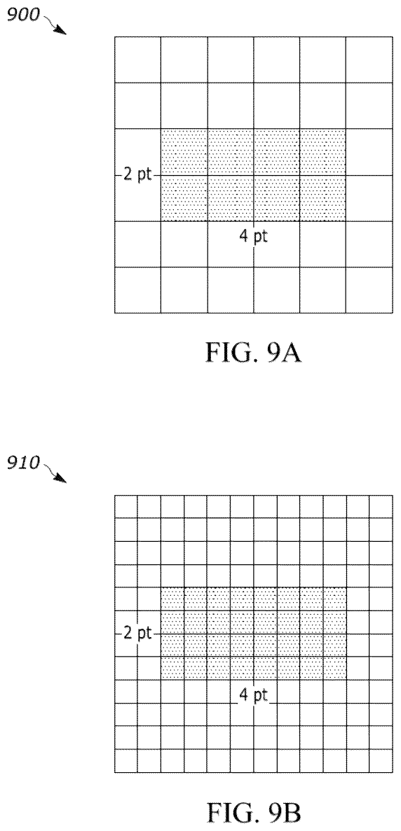

FIGS. 9A and 9B illustrate example techniques for determining 2D widget UI element positions and sizes during AI-powered 2D-to-3D UI feature conversion automation in accordance with this disclosure. For ease of explanation, two display grids 900 and 910 of FIGS. 9A and 9B are described as being used together with the automation system 300 of FIG. 3 and/or the training system 400 of FIG. 4 for generation 3D UI features for the electronic device 101. However, the display grids 900 and 910 may be used with any other suitable device(s) and in any other suitable system(s), and the 3D UI features may be provided to any other suitable device(s).

While digital screens have various sizes and shapes, the size and position of a widget UI relevant to the screen may stay consistent (using screen density-dependent unit, which allows UI to stay the same sizes for a range of devices, let alone different aspect ratios). For example, 2D UI widgets often follow a grid structure where the widget shape and size are aligned to the grid cells on the device display. FIG. 9A illustrates one density-dependent unit example where one point equates with one pixel, while FIG. 9B illustrates another density-dependent unit example where one point equates with two pixels.

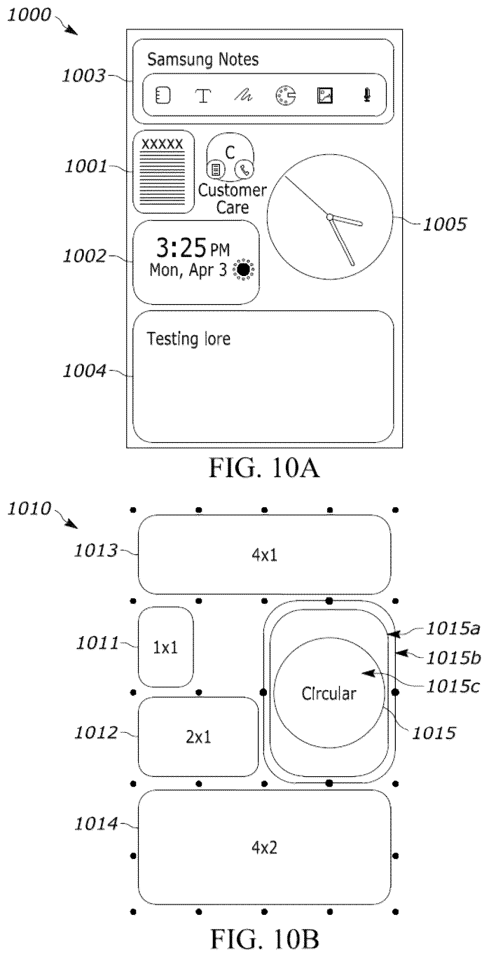

FIGS. 10A and 10B illustrate example determination of 2D widget UI size and placements on a display for different types of 2D widget UIs during AI-powered 2D-to-3D UI feature conversion automation in accordance with this disclosure. For case of explanation, a display 1000 of FIG. 10A and corresponding widget placements 1010 of FIG. 10B are described as being used together with the automation system 300 of FIG. 3 and/or the training system 400 of FIG. 4 for generation 3D UI features for the electronic device 101. However, the display 1000 and widget placements 1010 may be used with any other suitable device(s) and in any other suitable system(s), and the 3D UI features may be provided to any other suitable device(s).

By obtaining position and relevant sizing data, a widget design can be mapped to XR space on both vertical (such as wall) surfaces and horizontal (such as desk) surfaces. FIG. 10A depicts a display 1000 including five different types of 2D widget UIs, namely a single unit widget 1001, a double unit widget 1002, a long widget 1003, a large widget 1004, and a circular widget 1005. FIG. 10B depicts corresponding widget placements 1010 and sizes. In the examples of FIGS. 10A and 10B, the single unit widget 1001 occupies a single (1×1) grid element 1011 defined by coordinates (0,3), (0,4), (1,4), (1,3). The double unit widget 1001 occupies two (2×1) grid elements 1012 defined by coordinates (0,2), (0,3), (2,3), (2,2). However, other double unit widgets might occupy two (1×2) grid elements. The long widget 1003 occupies four (4×1) grid elements 1013 defined by coordinates (0,4), (0,5), (4,5), (4,4). The large widget 1004 occupies eight (4×2) grid elements 1014 defined by coordinates (0,0), (0,2), (4,2), (4,0). The circular widget 1005 occupies four (4×4) grid elements defined by coordinates (2,2), (2,4), (4,4), (4,2) and includes three components, namely placement highlighting 1015a, resizing guideline 1015b, and widget content 1015c.

FIGS. 11A and 11B illustrate example spatial mapping for 2D widget UI layering in generating a counterpart 3D widget UI during AI-powered 2D-to-3D UI feature conversion automation in accordance with this disclosure. For ease of explanation, a 2D widget UI 1100 of FIG. 11A and a corresponding 3D widget UI 1110 of FIG. 11B are described as being used together with the automation system 300 of FIG. 3 and/or the training system 400 of FIG. 4 for generation 3D UI features for the electronic device 101. However, the 2D widget UI 1100 and the 3D widget UI 1110 may be used with any other suitable device(s) and in any other suitable system(s), and the 3D UI features may be provided to any other suitable device(s).

The left side of each of FIGS. 11A and 11B illustrates a side view of a corresponding 2D widget UI 1100 or 3D widget UI 1110, while the right side of each of FIGS. 11A and 11B illustrates a front view. When introducing widgets from 2D screens into XR space, a new dimension (z-axis, such as depth) can be added to a matrix of the widget UI layout. To further optimize an information hierarchy in 3D space, a three-layering layout may be introduced. This layout may include a base layer 1111, which is a backbone layer for defining the size and shape of the 3D widget on which the rest of the UI elements sit. This layout may also include an optional staging layer 1112 for distinguishing interactive and non-interactive regions, which helps in building an information hierarchy of the content in space and distinguishing the non-interactive and interactive items. This layout may further include an active layer 1113, which is a layer for all active elements including user interactive items (such as active buttons), animated icons, and decorative 3D visual elements. Between each layer, there may be a specified fixed spacing or buffer.

In some cases, the extracted 2D widget UI elements can be arranged by categories. The following provides examples of such categories.
Base layer:
   Backing (with image or color texture)
   Text and non-interactive chunked elements sitting on the backing
Staging layer (introduced when elements of the below types are detected):
   Chunked elements with sub-backing
Active layer (introduced when elements of the below types are detected):
   Buttons
   Interactive chunked elements
   Decorative elements (3D) (animated and static)
   Video and gifs
      Layers closer to the user (in XR space) may include the more active and interactive elements.

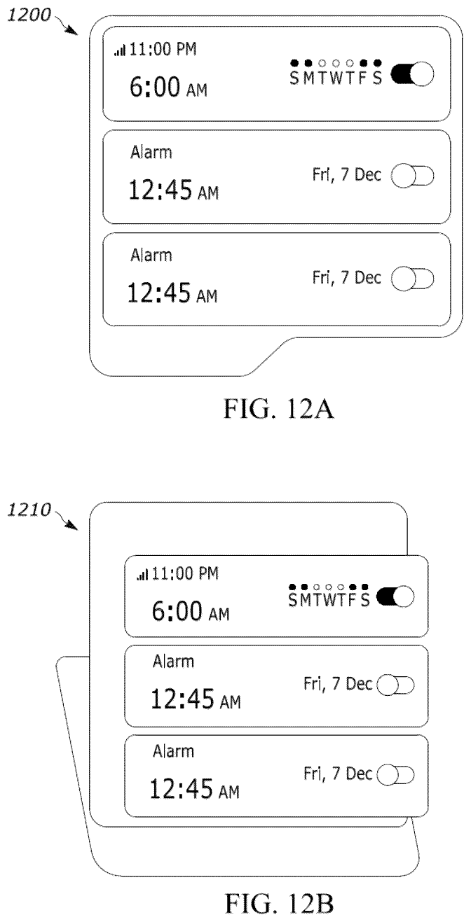

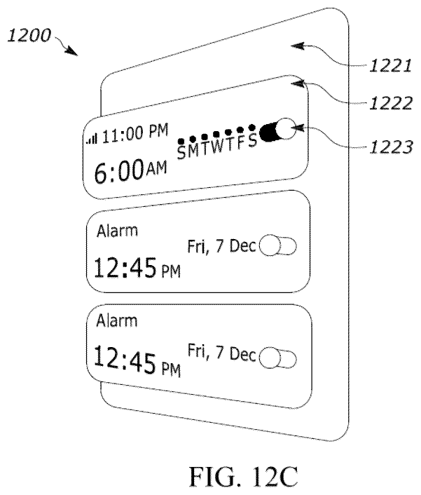

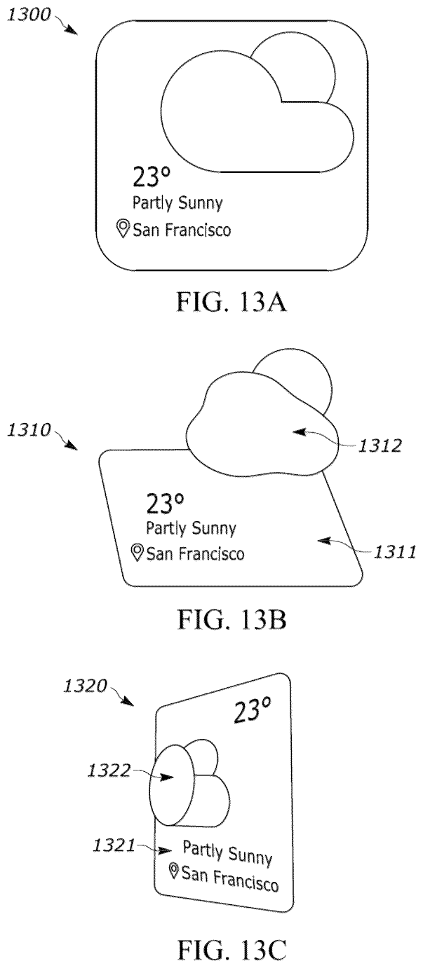

FIGS. 12A through 13C illustrate example 2D widget UIs and counterpart 3D widget UIs generated with AI-powered 2D-to-3D UI feature conversion automation in accordance with this disclosure. For ease of explanation, a 2D widget UI 1200 of FIG. 12A is described as being used together with the automation system 300 of FIG. 3 and/or the training system 400 of FIG. 4 for generation of a counterpart 3D widget UI 1210 of FIG. 12B and/or a counterpart 3D widget UI 1220 of FIG. 12C. Likewise, a 2D widget UI 1300 of FIG. 13A is described as being used together with the automation system 300 of FIG. 3 and/or the training system 400 of FIG. 4 for generation of a counterpart 3D widget UI 1310 of FIG. 13B and/or a counterpart 3D widget UI 1320 of FIG. 13C. Each of the 3D widget UIs 1210, 1220, 1310, and 1320 may be suitable for use with the electronic device 101. However, the 2D widget UIs 1200 and 1300 and the 3D widget UIs 1210, 1220, 1310, and 1320 may be used with any other suitable device(s) and in any other suitable system(s), and the 3D UI features may be provided to any other suitable device(s).

FIG. 12A depicts a 2D widget UI 1200 for use on a digital screen. FIG. 12B depicts a counterpart 3D widget UI 1210 generated as described above for use in connection with a horizontal surface type (such as a desk) in XR space. FIG. 12C depicts a counterpart 3D widget UI 1220 generated as described above for use in connection with a vertical surface type (such as a wall) in XR space. 3D widget UI 1220 is composed of a base layer 1221, a staging layer 1222, and an active layer 1223.

As part of 3D widget UI spatial mapping, determination of spatial coordinates and size in the 3D XR space can account for objects being placed on horizontal surfaces (such as desks or tables) or hanging on vertical surfaces (such as walls). In some embodiments, there may be various ways to map the spatial coordinates of the widgets in the 3D space. For example, the following approach may be used.
The horizontal and vertical surfaces can be determined with plane detection in the user space. Images acquired by world-facing cameras in the user space can be analyzed to determined planes on the floor(s), table(s), desk(s), and wall(s) to form horizontal and vertical planes.
The planes can be marked for wall or desk surface types on which 3D widgets may be placed.
The widgets may appear differently based on the surface type on which each widget has been placed (or moved) by the user or the system.
On a wall, UI elements may be aligned to a vertical surface. On a horizontal surface, UI elements may use different angles and may be offset so that the user can access the UI elements for interaction and is able to read information on the widgets or UI elements.

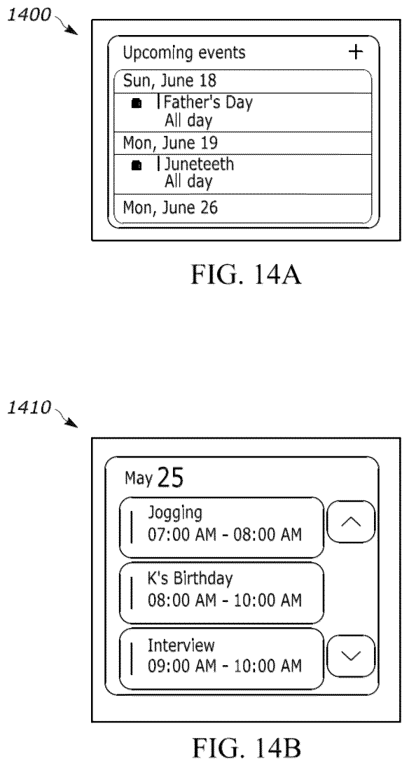

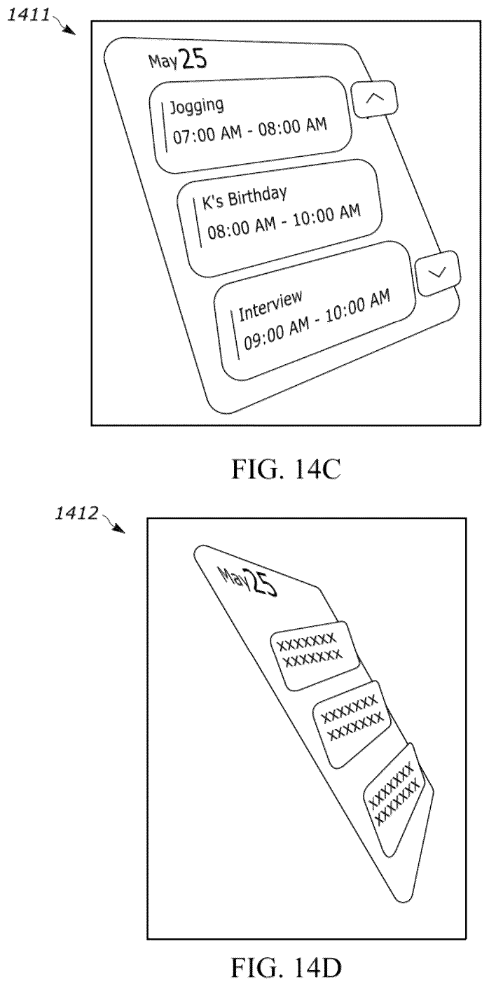

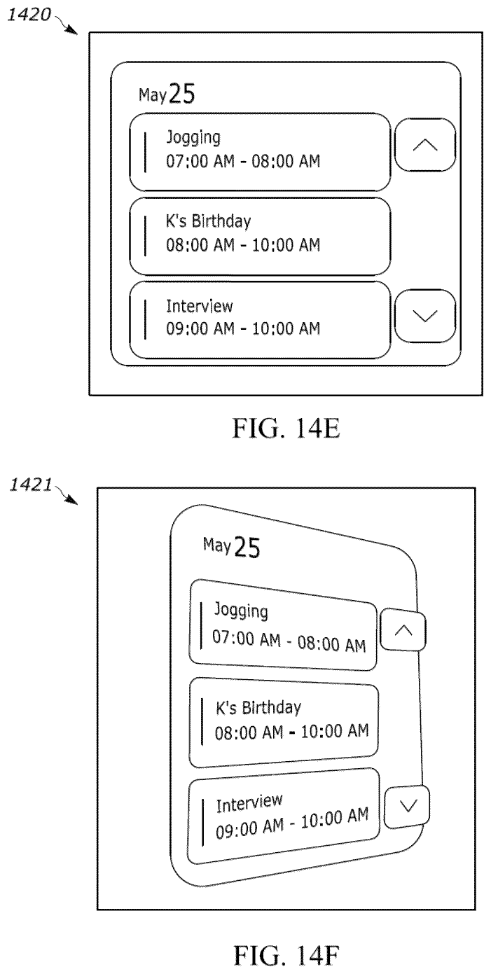

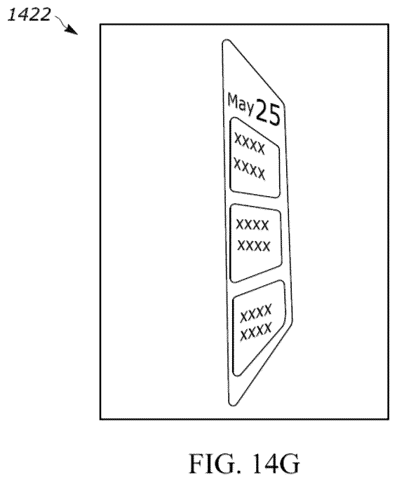

FIGS. 14A through 14G illustrate another example 2D widget UIs and counterpart 3D widget UIs generated with AI-powered 2D-to-3D UI feature conversion automation in accordance with this disclosure. For case of explanation, a 2D widget UI 1400 of FIG. 14A is described as being used together with the automation system 300 of FIG. 3 and/or the training system 400 of FIG. 4 for generation of a counterpart 3D widget UI illustrated by views 1410-1414 in FIGS. 14B through 14D and by views 1420-1422 in FIGS. 14E through 14G. Each of the 3D widget UIs may be suitable for use with the electronic device 101. However, the 2D widget UI 1400 and the 3D widget UIs may be used with any other suitable device(s) and in any other suitable system(s), and the 3D UI features may be provided to any other suitable device(s).

FIG. 14A illustrates a 2D widget UI 1400 for a mobile device. FIGS. 14B through 14D are various views of a counterpart 3D widget UI for a horizontal surface in XR space, where view 1410 in FIG. 14B is a front view, view 1411 in FIG. 14C is a three-quarters view, and view 1412 in FIG. 14D is a side view. FIGS. 14E through 14G are various views of a counterpart 3D widget UI for a vertical surface in XR space, where view 1420 in FIG. 14E is a front view, view 1421 in FIG. 14F is a three-quarters view, and view 1422 in FIG. 14G is a side view.

In another part of 3D widget UI spatial mapping, the grid system in XR space may have a grid layout for horizontal and vertical surfaces with a fixed grid cell size. As the grid cell size on phones is smaller and closer to the user's eyes than in XR space, the number of grid cells used for a widget UI on a phone screen may not be equal to the number of cells used in XR space. In some embodiments, for horizontal surfaces in XR space, the UI object size may be at least 12×12 centimeters (cm) without considering thickness in order to be comfortably read and comprehended by users at a distance of about one meter (m). On a vertical surface, the grid unit might be even larger since the widget UI may be further away from the users. The transfer from 2D screens to XR surfaces can use a mapping mechanism employing fewer grid blocks in the XR space (explained below) so that the 3D widgets do not appear too large for users.

The dimensions of a widget grid block in XR space may depend on the 2D grid unit dimensions of the widget, which need not necessarily be square. Grid block rendering on horizontal and vertical surfaces can be different so that rendering can better accommodate widget shapes and more efficiently utilize space. In some embodiments, widget dimensions and associated unit grids for vertical surfaces may be in portrait rectangles. Accordingly, on vertical XR surfaces, the height of a grid block (on the z-axis) may be adjusted appropriately to accommodate the standing of the rectangular widget, while a horizontal surface grid may remain square.

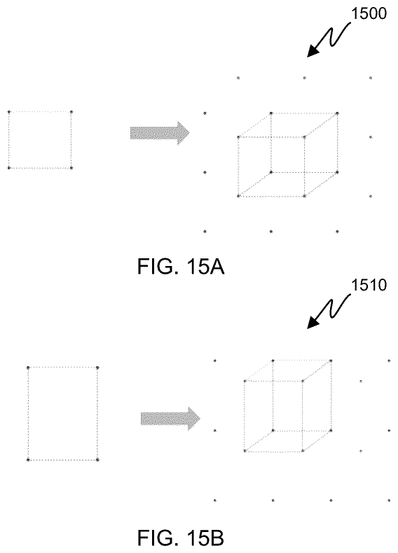

FIGS. 15A and 15B illustrate an example 2D widget UI grid mapping to a counterpart 3D widget UI grid during AI-powered 2D-to-3D UI feature conversion automation in accordance with this disclosure. For ease of explanation, two grid mappings 1500 and 1510 are described as being used together with the automation system 300 of FIG. 3 and/or the training system 400 of FIG. 4 for generation of counterpart 3D widget UIs from 2D widget UIs. Each of the 3D widget UIs may be suitable for use with the electronic device 101. However, the grid mappings 1500 and 1510 may be used with any other suitable device(s) and in any other suitable system(s), and the 3D UI features may be provided to any other suitable device(s).

FIG. 15A illustrates one 2D grid unit on a mobile device (left side) having (X,Y) dimensions of 1×1 and approximate display dimensions of 1 cm×1 cm for viewing at a distance of about 30 cm. That single 2D grid unit may be mapped in the horizontal and vertical directions to a single 3D grid block (right side) having (X,Y,Z) dimensions of 1×1×1 and approximate display dimensions of 12 cm×12 cm×12 cm for viewing at a distance of about 1 m. As discussed above, this grid mapping to a square cube may be suitable for 3D widget UIs to be displayed on a horizontal surface.

FIG. 15B also illustrates one 2D grid unit on a mobile device (left side) having (X,Y) dimensions of 1×1 and approximate display dimensions of 1 cm×1 cm for viewing at a distance of about 30 cm. That single 2D grid unit may be mapped in the horizontal and vertical directions to a single 3D grid block (right side) having (X,Y,Z) dimensions of 1×1×1 but with approximate display dimensions of 12 cm×12 cm×15 cm for viewing at a distance of about 1 m. As discussed above, this grid mapping to a portrait rectangular cuboid (rectangular prism) may be suitable for 3D widget UIs to be displayed on a vertical surface.

In some embodiments, for purposes of mapping and conversion, the widget dimensions that determine the number of grid blocks used in XR space with a mapping mechanism and conditions may be explained as follows.
If a 2D widget takes up one grid unit (1×1) on a phone, the 3D widget may use one grid block (1×1) in XR space.
The converted 3D widgets may take up the width and height of the grid blocks with a slight offset margin. All widget elements may be contained in the volume formed by the number of grid cells used.
Widgets with a width or height no larger than two grid units (such as 2×1 or 1×2) may use one grid block in XR space, as 1×1×1 is sufficient to contain all the widget elements in XR.
2D widgets with more than two grid units as the width or height (such as 3×1, 4×1, 4×2, or larger) may occupy two grid blocks (such as 2×1×1, 2×2×1) in XR space.
No widget dimension in XR space may go beyond 2×2×1 so as to not overshadow apps and become too large, intimidating users.
The thickness of a 3D widget may vary depending on the total thickness of all layers, the presence of elements with a tilting angled applied, and the spacing in between layers. The maximum thickness may be one grid block.

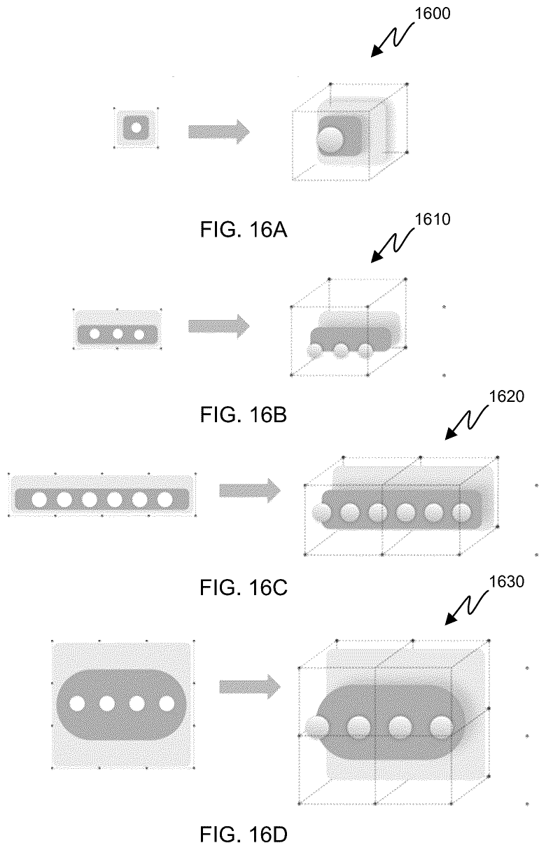

FIGS. 16A through 16D illustrate example grid mappings for specific 2D widget UIs to counterpart 3D widget UIs during AI-powered 2D-to-3D UI feature conversion automation in accordance with this disclosure. For ease of explanation, four grid mappings 1600, 1610, 1620, and 1630 are described as being used together with the automation system 300 of FIG. 3 and/or the training system 400 of FIG. 4 for generation of counterpart 3D widget UIs from 2D widget UIs. Each of the 3D widget UIs may be suitable for use with the electronic device 101. However, the grid mappings 1600, 1610, 1620, and 1630 may be used with any other suitable device(s) and in any other suitable system(s), and the 3D UI features may be provided to any other suitable device(s).

FIG. 16A illustrates a grid mapping 1600 for a 1×1 (X,Y) 2D widget UI feature for a phone display and the corresponding 1 grid block of 1×1×1 (X,Y,Z) of a three-layer 3D widget UI feature. FIG. 16B illustrates a grid mapping 1610 for a 2×1 (X,Y) 2D widget UI feature for a phone display and the corresponding 1 grid block of 1×1×1 (X,Y,Z) of a three-layer 3D widget UI feature. FIG. 16C illustrates a grid mapping 1620 for a 4×1 (X,Y) 2D widget UI feature for a phone display and the corresponding 2 grid blocks of 2×1×1 (X,Y,Z) of a three-layer 3D widget UI feature. FIG. 16D illustrates a grid mapping 1630 for a 3×3 (X,Y) 2D widget UI feature for a phone display and the corresponding 4 grid blocks of 2×2×1 (X,Y,Z) of a three-layer 3D widget UI feature.

A further part of 3D widget UI spatial mapping may relate to pivot point, center, and tilting angles. The pivot point of a widget may automatically be set to the center of the base layer, which acts as a parent for the rest of the layers (such as staging and active). For horizontal surface widgets, when widgets are mapped to grid blocks, the base layer center point may automatically be aligned with the center of the grid block with an offset thickness. For vertical surface widgets, the base layer may attach to the grid block's back wall (x-y plane) of the grid block with an offset margin, and the center point may automatically be aligned with the center point on the back wall.

With respect to tilting angles, comfortable UI placement when showing UI features for a long time may be between about 15° and about 30°. Accordingly, 3D widgets on horizontal surfaces may be tilted, such as at an angle of about 15°, by default. No tilting angles may be applied to vertical surface widgets, as the widgets are closely attached to walls. A bounding grid block can constrain the tilting angle to avoid protrusion (discussed below).

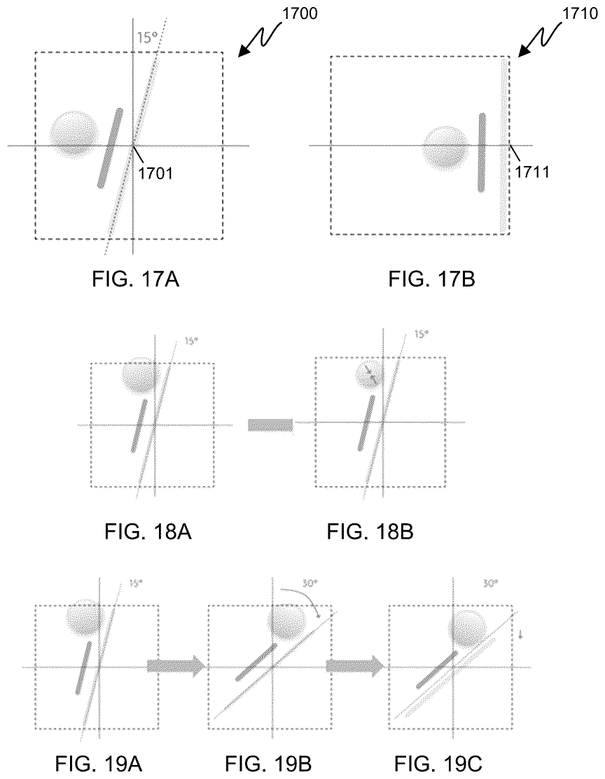

FIGS. 17A and 17B illustrate example pivot point, center, and tilting for a three-layer 3D widget UI feature generated during AI-powered 2D-to-3D UI feature conversion automation in accordance with this disclosure. More specifically, FIG. 17A illustrates, from a side view 1700 of a grid block, a pivot point and center 1701 of a 3D widget feature on a horizontal surface with a default tilting angle of 15°. FIG. 17B illustrates, from a side view 1710 of a grid block, a pivot point and center 1711 of a 3D widget feature on a vertical surface with a default tilting angle of 0°.

To avoid protrusion of volumetric 3D elements from the boundaries of a grid block, one or more solutions may be employed. The following provides two examples of such solutions.
Option 1: A 3D element may shrink accordingly to not protrude from a grid block.
Option 2:
   The tilting angle may be automatically adjusted, such as up to about 30°, to accommodate the protruded volume.
   If the protrusion still exists, the base layer may be pushed appropriately within a grid block until the volumes are entirely inside the grid block.
      A user can also adjust the titling angle based on his or her needs afterwards.

FIGS. 18A through 19C illustrate example solutions to avoiding protrusion of 3D widget UI feature elements generated during AI-powered 2D-to-3D UI feature conversion automation in accordance with this disclosure. Side views of a grid block are presented in each of FIGS. 18A and 18B and FIGS. 19A through 19C. FIGS. 18A and 18B collectively illustrate a widget element in an active layer initially protruding outside a grid block and being shrunk to fit within the grid block. FIGS. 19A through 19C collectively illustrate the same widget, with the same widget element initially protruding outside the grid block, being rotated from 15° to 30° (compare FIGS. 19A and 19B) and shifted (compare FIGS. 19B and 19C) until all widget elements are inside the grid block.

For purposes of output rendering for the widget visual representation in XR space, colors may be picked based on 2D widget images and baked to the 3D widgets, which can include shading properties. In some embodiments, the 3D widget may be in a standard output format, such as FBX or OBJ format. In other cases, widget panels could have some fixed thickness shown in the images.

Spawning 3D decorative elements and icons may be performed during AI-powered 2D-to-3D UI feature conversion automation. Elements assigned to an active layer (such as buttons, icons, decorative elements, etc.) may be made 3D, making those elements more visually interesting because depth is introduced in XR space. In XR space, the user can see the object in stereoscopic 3D and can interact with the object and view the object from the sides.

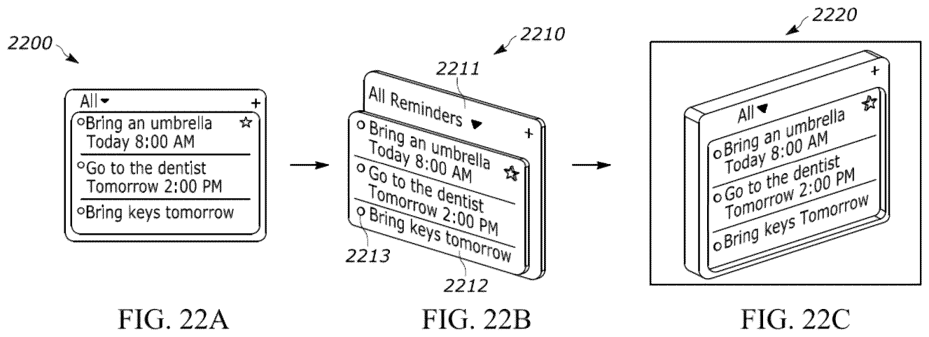

FIGS. 20A through 22C illustrate examples of making widget elements more interesting during AI-powered 2D-to-3D UI feature conversion automation in accordance with this disclosure. In FIG. 20A, a 2D widget UI 2000 is for weather, with text and decorative elements (sun and moon). During output rendering illustrated by an initial 3D widget UI 2010 in FIG. 20B, the decorative elements (such as the sun 2012) on a base layer 2011 are rendered in 3D, resulting in a 3D widget UI 2020 in FIG. 20C, where the sun is hemispherical with projecting rays. A 2D widget UI 2100 in FIG. 21A is for calendar items. A converted 3D widget UI 2110 in FIG. 21B includes a base layer 2111 with a 3D element 2112 thereon and a staging layer 2113 with 3D elements 2114 thereon. The resulting 3D widget UI 2120 includes 3D features on both the base and staging layers. A 2D widget UI 2200 in FIG. 22A is for reminders. A converted 3D widget UI 2210 in FIG. 22B includes a base layer 2211, a staging layer 2212, and 3D elements 2213. A resulting 3D widget UI 2220 includes 3D features such as projecting balls rather than columns for radio buttons and a non-columnar 3D star (compare FIG. 22B and FIG. 22C).

Besides merely extruding elements and adding fixed thicknesses to render more stylized 3D objects, 2D graphics may be replaced with stylized 3D objects. For example, labels (previously defined and extracted by segmentation) can be used to locate matching 3D icons. Once an object is matched, elements can be replaced with a 3D version.

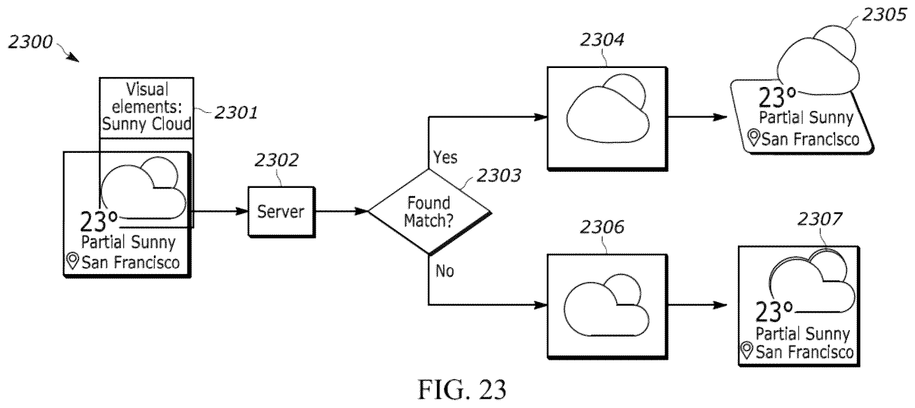

FIG. 23 illustrates an example portion 2300 of AI-powered 2D-to-3D UI feature conversion automation relating to object matching in accordance with this disclosure. A label for a visual element 2301 (a partly sunny cloud image in the example shown) is used to query a server 2302 for matching 3D objects already created. If a match is found (determination 2303), a 2D icon 2304 is replaced on a 3D widget UI 2305 with located stylized 3D icon. If no match is located, the 2D icon 2304 is thickened by extruding the icon, and the resulting thickened icon 2306 is used on the 3D widget UI.

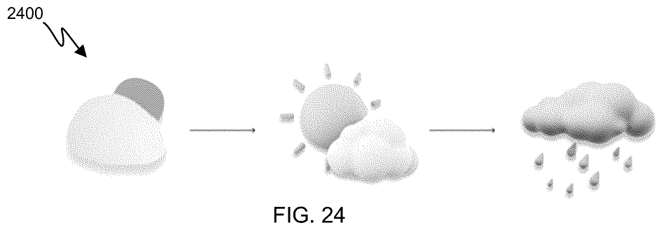

The 3D icons can also be animated or provided with dynamic real-time effects (such as a 3D cloud becomes muddy for stormy weather). FIG. 24 illustrates an example portion 2400 of AI-powered 2D-to-3D UI feature conversion automation relating to adding dynamic real-time effects in accordance with this disclosure. In the effects depicted, a partly sunny icon changes to a cloud moving to obscure the sun and then to a dark cloud with falling raindrops.

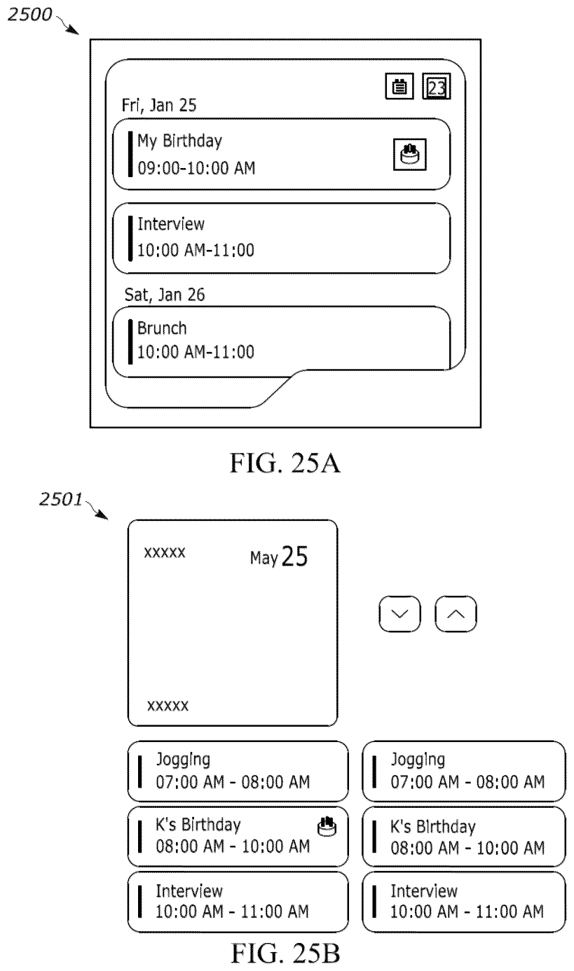

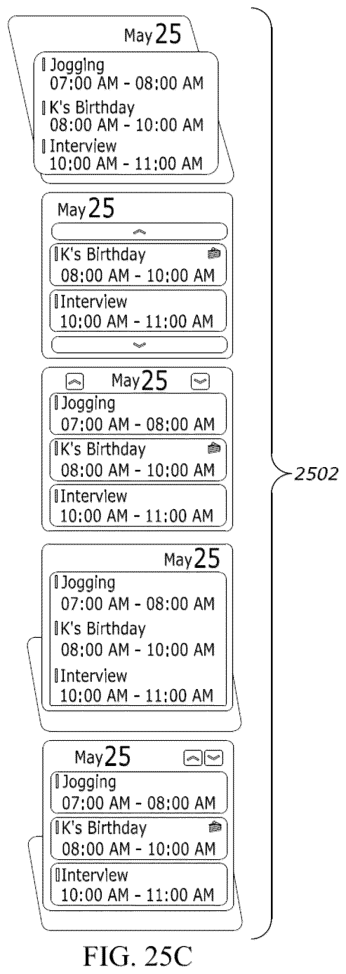

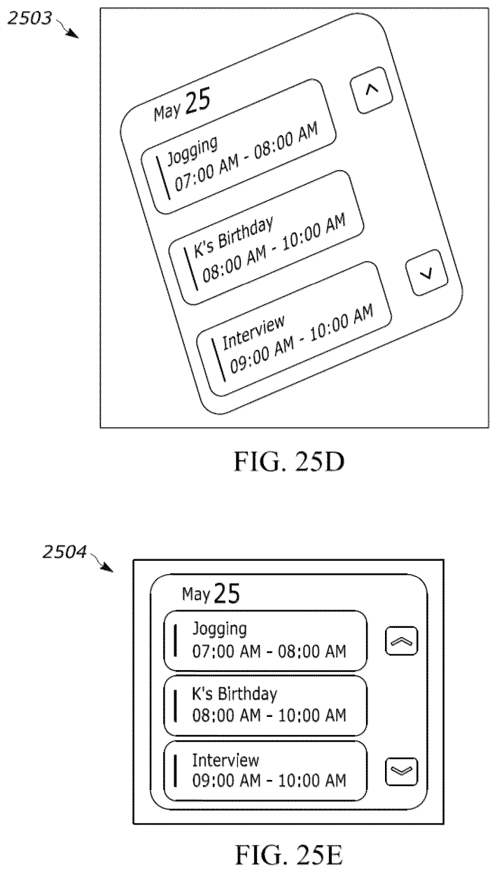

FIGS. 25A through 25E illustrate a specific example of AI-powered 2D-to-3D UI feature conversion automation in accordance with this disclosure. More specifically, FIGS. 25A through 25E illustrate AI-powered 2D-to-3D UI feature conversion automation with automation rules applied to a calendar widget. A 2D widget UI 2500 in FIG. 25A is used to derive inputs, which are analyzed into a set 2501 of elements with inactive chunkings as shown in FIG. 25B. Using the chunkings, layout iterations 2502 shown in FIG. 25C are performed. The output includes a 3D widget UI 2503 for use with horizontal surfaces as shown in FIG. 25D and a 3D widget UI 2504 for use with vertical surfaces as shown in FIG. 25E.

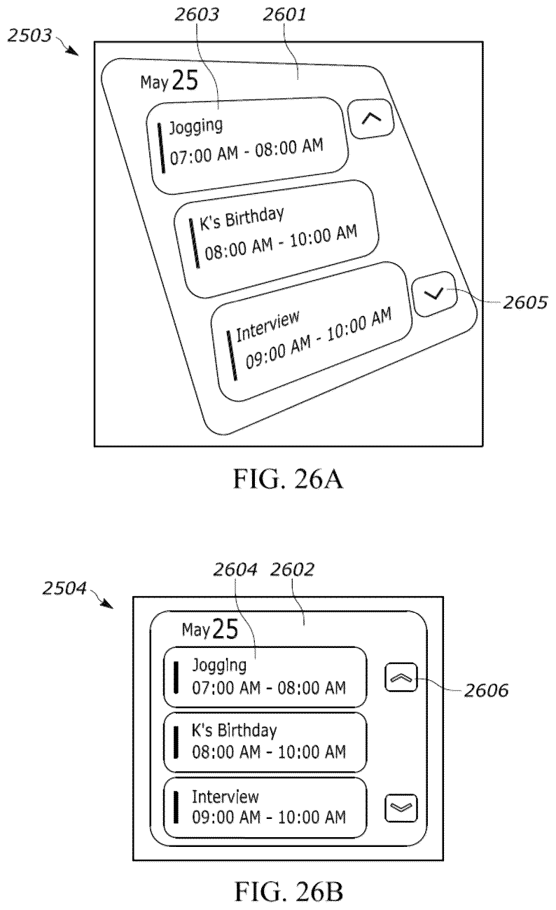

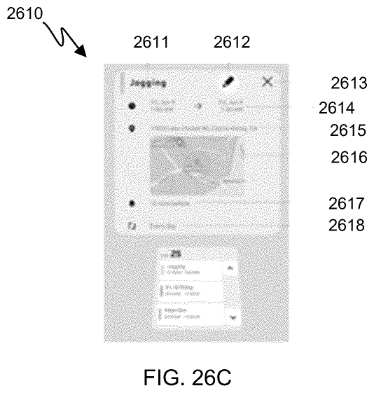

FIGS. 26A through 26C illustrate use of the 3D widget UI 2503 of FIG. 25D or the 3D widget UI 2504 of FIG. 25E in XR space in accordance with this disclosure. For the calendar widget illustrated, a date in both the 3D widget UI 2503 and the 3D widget UI 2504 is placed flat on the corresponding tilted or flat backing 2601, 2602 to imply that the displayed text is not interactable. Respective agenda buttons 2603, 2604 and scroll buttons 2605, 2606 can be provided. On the 3D widget UI 2503 for horizontal surfaces, the scroll buttons 2605 may be popped vertically to avoid misfires, inviting the user to scroll the agenda. Also on the 3D widget UI 2503, events represented by agenda buttons are chunked and popped individually, implying that users may expand each individual event. The user can open a specific agenda item of the 3D widget UI and edit that event in an expanded panel 2610 shown in FIG. 26C. Data or user controls available in the expanded panel may include an event title 2611, an edit control 2612, a close control 2613 for closing the expanded panel, the event date/time 2614, the event address 2615, a map 2616 to or for the event, an event notification setting 2617, and an event recurrence setting 2618.

Although FIGS. 5 through 26C illustrate various example embodiments and related details for AI-powered 2D-to-3D UI feature conversion automation, various changes may be made to FIGS. 5 through 26C. For example, the contents of these figures are for illustration and explanation only, and these figures do not limit the scope of this disclosure to the illustrated details.

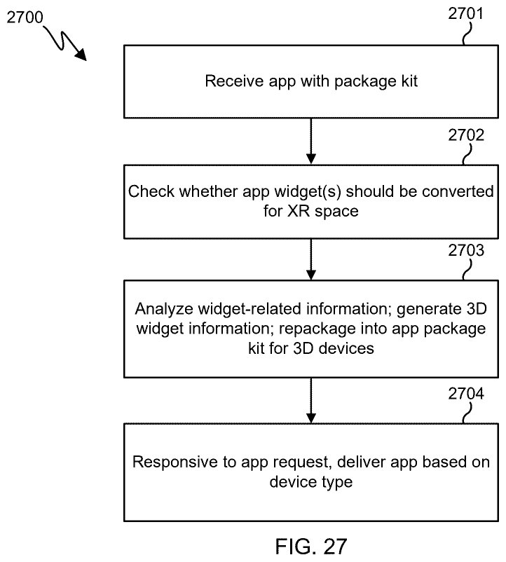

FIG. 27 illustrates an example process 2700 for automatically converting 2D UI features in an app to 3D UI features suitable for an XR environment in accordance with this disclosure. For ease of explanation, the process 2700 of FIG. 27 is described as being performed using the server 106 in the network configuration 100 of FIG. 1, such as to create 3D UI features for an app executing on the electronic device 101. However, the process 2700 may be performed using any other suitable device(s), such as the electronic device 101, and in any other suitable system(s).

As shown in FIG. 27, the process 2700 begins by receiving an app and an associated app package kit (APK) in which the app employs a 2D UI feature (step 2701). For example, the app may be an ANDROID app, and the app and associated APK may be uploaded by an app developer to an online store for registration. The process 2700 may execute in connection with upload of the app and associated app package kit to the online store and/or with registration of the app. The uploaded app package kit may contain information related to widgets (such as a manifest file, extended markup language (XML) data, etc.).

The app and/or app package kit registered by the developer with the online store are checked to determine whether any 2D UI features should be converted for use with XR devices (step 2702). For example, widgets for the app may be determined to be suitable for conversion to XR space as described above. Optionally, the conversion may be set to occur automatically, or the developer may be prompted to initiate conversion if desired.

When the app or app packet kit is determined to involve one or more 2D UI features that should be converted for use with XR devices, the 2D UI feature information for the app package kit is analyzed, the above-described techniques are employed to automatically convert the 2D UI features into 3D UI features suitable for XR devices, and the app is repackaged into an app package kit suitable for 3D devices (step 2703). For example, widget-related information in the app package kit can be analyzed and automatically converted into counterpart 3D widget information, and the 3D widgets can be packaged into an app or app package kit for 3D devices, which is optionally distinct from the app and app package kit uploaded for registration.

Both the app and app package kit for use with a general smartphone (or tablet, etc.) and the app and app package kit for use with 3D devices may be retained in the app store. When a user seeks to install the app, the app and app package kit suitable for the device type or specification is delivered to the user (step 2704). For instance, when the request originates with a user operating a 3D device, the version of the app and app package kit for use with 3D devices may be delivered, while the version of the app and app package kit for use with a general smartphone is delivered when the request originates from a smartphone.

Although FIG. 27 illustrates one example of a process 2700 for automatically converting 2D UI features in an app to 3D UI features suitable for an XR environment, various changes may be made to FIG. 27. For example, while shown as a series of steps, various steps in FIG. 27 could overlap, occur in parallel, occur in a different order, or occur any number of times (including zero times).

The present disclosure allows automatic (such as AI-assisted) conversion of a 2D widget UI to a 3D widget UI suitable for XR environments by (i) obtaining a 2D widget UI design, (ii) analyzing elements of the 2D widget UI design, (iii) determining spatial coordinates in a 3D XR space for each analyzed element, and (iv) rendering the analyzed elements at the determined spatial coordinates to form the 3D widgets. Interactions for 2D widget UI elements can be detected and translated to commands in XR space for the corresponding 3D widget UI elements. Analyzing elements of the 2D widget UI layout could include identifying buttons, text, graphics, and other elements (such as backing, stats, time/date, chunking, decorative element, and media display) that are ready to be converted into 3D widgets with consideration of element interactivity and dynamic effects in 3D spaces. Determination of spatial coordinates in a 3D XR space could include computing depth values for each analyzed element based on predefined depth profiles and consideration of placement on for both vertical and horizontal surface, where the depth profiles can be determined based on the hierarchy or importance of the UI elements.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method for automatically converting a two-dimensional (2D) user interface (UI) feature to a three-dimensional (3D) UI feature suitable for an extended reality (XR) environment, the method comprising:
obtaining a design for the 2D UI feature;
analyzing elements of the design for the 2D UI feature;
determining spatial coordinates in a 3D XR space corresponding to each element of the design for the 2D UI feature; and
rendering elements for the 3D UI feature at the determined spatial coordinates to form the 3D UI feature.

2. The method of claim 1, further comprising:
determining interactions for the elements of the 3D UI feature in the 3D XR space; and
translating the interactions into commands based on corresponding commands for the elements of the design for the 2D UI feature, wherein the translation is based at least in part on one or more user considerations.

3. The method of claim 1, wherein analyzing the elements of the design for the 2D UI feature comprises identifying, using an artificial intelligence (AI) or machine learning (ML) model, at least one of: buttons, text, graphics, backing, statistics, time/date, chunking, decorative elements, or media display.

4. The method of claim 1, wherein determining the spatial coordinates in the 3D XR space comprises identifying, using an artificial intelligence (AI) or machine learning (ML) model, depth values for the elements for the 3D UI feature based on one or more depth profiles.

5. The method of claim 4, wherein the one or more depth profiles are based on a hierarchy of the elements for the 3D UI feature.

6. The method of claim 1, further comprising:
adjusting at least one of a size or an orientation of the elements for the 3D UI feature in the 3D XR space based on a user experience during interactions with the 3D UI feature.

7. The method of claim 1, further comprising:
adding one or more dynamic effects to one or more of the elements of the 3D UI feature;
wherein the one or more dynamic effects include at least one of: animation, shadowing, reflection, or ambient interaction based on user presence.

8. An electronic device for automatically converting a two-dimensional (2D) user interface (UI) feature to a three-dimensional (3D) UI feature suitable for an extended reality (XR) environment, the electronic device comprising:
at least one processing device configured to:
obtain a design for the 2D UI feature;
analyze elements of the design for the 2D UI feature;
determine spatial coordinates in a 3D XR space corresponding to each element of the design for the 2D UI feature; and
render elements for the 3D UI feature at the determined spatial coordinates to form the 3D UI feature.

9. The electronic device of claim 8, wherein the at least one processing device is further configured to:
determine interactions for the elements of the 3D UI feature in the 3D XR space; and
translate the interactions into commands based on corresponding commands for the elements of the design for the 2D UI feature, wherein the translation is based at least in part on one or more user considerations.

10. The electronic device of claim 8, wherein, to analyze the elements of the design for the 2D UI feature, the at least one processing device is configured to identify, using an artificial intelligence (AI) or machine learning (ML) model, at least one of: buttons, text, graphics, backing, statistics, time/date, chunking, decorative elements, or media display.

11. The electronic device of claim 8, wherein, to determine the spatial coordinates in the 3D XR space, the at least one processing device is configured to identify, using an artificial intelligence (AI) or machine learning (ML) model, depth values for the elements for the 3D UI feature based on one or more depth profiles.

12. The electronic device of claim 11, wherein the one or more depth profiles are based on a hierarchy of the elements for the 3D UI feature.

13. The electronic device of claim 8, wherein the at least one processing device is further configured to adjust at least one of a size or an orientation of the elements for the 3D UI feature in the 3D XR space based on a user experience during interactions with the 3D UI feature.

14. The electronic device of claim 8, wherein:
the at least one processing device is further configured to add one or more dynamic effects to one or more of the elements of the 3D UI feature; and
the one or more dynamic effects include at least one of: animation, shadowing, reflection, or ambient interaction based on user presence.

15. A non-transitory machine readable medium for automatically converting a two-dimensional (2D) user interface (UI) feature to a three-dimensional (3D) UI feature suitable for an extended reality (XR) environment, the non-transitory machine readable medium containing instructions that when executed cause at least one processor of an electronic device to:
obtain a design for the 2D UI feature;
analyze elements of the design for the 2D UI feature;
determine spatial coordinates in a 3D XR space corresponding to each element of the design for the 2D UI feature; and
render elements for the 3D UI feature at the determined spatial coordinates to form the 3D UI feature.

16. The non-transitory machine readable medium of claim 15, further containing instructions that when executed cause the at least one processor to:
determine interactions for the elements of the 3D UI feature in the 3D XR space; and
translate the interactions into commands based on corresponding commands for the elements of the design for the 2D UI feature, wherein the translation is based at least in part on one or more user considerations.

17. The non-transitory machine readable medium of claim 16, wherein the instructions that when executed cause the at least one processor to analyze the elements of the design for the 2D UI feature comprise:
instructions that when executed cause the at least one processor to identify, using an artificial intelligence (AI) or machine learning (ML) model, at least one of: buttons, text, graphics, backing, statistics, time/date, chunking, decorative elements, or media display.

18. The non-transitory machine readable medium of claim 15, wherein the instructions that when executed cause the at least one processor to determine the spatial coordinates in the 3D XR space comprise:
instructions that when executed cause the at least one processor to identify, using an artificial intelligence (AI) or machine learning (ML) model, depth values for the elements for the 3D UI feature based on one or more depth profiles.

19. The non-transitory machine readable medium of claim 18, wherein the one or more depth profiles are based on a hierarchy of the elements for the 3D UI feature.

20. The non-transitory machine readable medium of claim 15, further containing instructions that when executed cause the at least one processor to:
adjust at least one of a size or an orientation of the elements for the 3D UI feature in the 3D XR space based on a user experience during interactions with the 3D UI feature.
